(19) United States
(12) Patent Application Publication
(10) Pub. No.: US 2015/0244786 A1
(43) Pub. Date: Aug. 27, 2015

(54) Method And Apparatus For Managing Multimedia Resource And Multimedia Player

(71) Applicant: TENCENT TECHNOLOGY (SHENZHEN) COMPANY LIMITED, Shenzhen City (CN)

(72) Inventors: Jinfang YANG, Shenzhen (CN); Wenwei XIN, Shenzhen (CN); Yilan LIU, Shenzhen (CN); Bo HE, Shenzhen (CN); Xiaoyi LIAO, Shenzhen (CN); Yijun GAO, Shenzhen (CN); Heng ZENG, Shenzhen (CN); Fengchun LI, Shenzhen (CN); Chuxiong HUANG, Shenzhen (CN); Yang GUO, Shenzhen (CN); Jing LI, Shenzhen (CN); Yaoming HUANG, Shenzhen (CN)

(21) Appl. No.: 14/708,725

(22) Filed: May 11, 2015

Related U.S. Application Data
(63) Continuation of application No. PCT/CN2013/084173, filed on Sep. 25, 2013.

(30) Foreign Application Priority Data
Nov. 14, 2012 (CN) 201210456332.1

(51) Int. Cl. H04L 29/08; H04L 29/06; G06F 17/30

(52) U.S. Cl. CPC H04L 67/10; G06F 17/30752; H04L 65/60

(57) ABSTRACT

A method and an apparatus for managing multimedia resources and a multimedia player is described. The method includes obtaining, by a multimedia application, multimedia resource information. The multimedia resource information includes information of a multimedia resource that has not been downloaded to a local end. The method further includes detecting, by the multimedia application, whether a network environment on the local end includes a downloadable link and downloading automatically, if a detection result is yes, the corresponding multimedia resource through the downloadable link according to the information of the multimedia resource that has not been downloaded to the local end.

### CROSS-REFERENCE TO RELATED APPLICATIONS

This application is a continuation of International Application No. PCT/CN2013/084173, filed Sep. 25, 2013. This application claims the benefit and priority of Chinese Application No. 201210456332.1, filed Nov. 14, 2012. The entire disclosures of each of the above applications are incorporated herein by reference.

### FIELD

The present disclosure relates to managing a multimedia resource and a multimedia player.

### BACKGROUND

This section provides background information related to the present disclosure which is not necessarily prior art.

In existing applications of network terminals, music playing is combined with Internet technologies to achieve synchronization of selected songs between different terminals. However, in existing synchronization of songs, the information of the songs is synchronized, but files of the songs typically are not. Alternatively, the terminals download information of the songs from the Internet and do not download complete files of the songs.

It is difficult to manage songs in music playing applications on the terminals. To listen to songs on a mobile terminal, a user may need to download the songs in real time. When a network condition is not favorable, the user cannot listen to songs of which only the information exists in the terminal.

### SUMMARY

This section provides a general summary of the disclosure, and is not a comprehensive disclosure of its full scope or all of its features.

According to various embodiments, a method for managing a multimedia resource is provided, including:

obtaining, by a multimedia application, multimedia resource information, the multimedia resource information including information of a multimedia resource that has not been downloaded to a local end; and detecting, by the multimedia application, whether a network environment on the local end includes a downloadable link, and downloading automatically, if a detection result is yes, the corresponding multimedia resource through the downloadable link according to the information of the multimedia resource that has not been downloaded to the local end.

The obtaining, by a multimedia application, multimedia resource information includes:

obtaining, by the multimedia application, changed multimedia resource information, detecting whether the changed multimedia resource information includes the information of the multimedia resource that has not been downloaded to the local end, and starting, if a detection result is yes, detecting, by the multimedia application, whether a network environment on the local end includes a downloadable link.

In various embodiments, the obtaining, by a multimedia application, multimedia resource information includes performing multimedia resource synchronization between the local end and another terminal, and obtaining, by the multimedia application, synchronized multimedia resource information.

The downloadable link is a predefined non-flow based charging connection, and the non-flow based charging connection refers to a network connection for which charging is not performed based on a download flow. Specifically, the non-flow based charging connection refers to a Wi-Fi connection.

The multimedia resource information includes a local favorite song list and a songs-to-be-downloaded list.

According to various embodiments, an apparatus for managing multimedia resources is further provided, including:

an information acquisition unit, configured to obtain multimedia resource information, the multimedia resource information including information of a multimedia resource that has not been downloaded to a local end; and

a detection and download unit, configured to detect whether a network environment on the local end includes a downloadable link, and download automatically, if a detection result is yes, the corresponding multimedia resource through the downloadable link according to the information of the multimedia resource that has not been downloaded to the local end.

The information acquisition unit is further configured to obtain synchronized multimedia resource information after multimedia resource synchronization is performed between the local end and another terminal.

The information acquisition unit includes:

an information acquisition subunit, configured to obtain changed multimedia resource information; and

an information detection subunit, configured to detect whether the changed multimedia resource information includes the information of the multimedia resource that has not been downloaded to the local end, and start, if a detection result is yes, the detection and download unit to conduct detection and downloading.

The downloadable link detected by the detection and download unit is a predefined non-flow based charging connection, and the non-flow based charging connection refers to a network connection for which charging is not performed based on a download flow.

The multimedia resource information acquired by the information acquisition unit includes a local favorite song list and a songs-to-be-downloaded list.

According to various embodiments, a multimedia player is further provided, including the apparatus for managing a multimedia resource in various embodiments.

The implementation of the various embodiments of the present disclosure can offer various benefits. In the various embodiments of the present disclosure, if multimedia resource information is already available locally, but a multimedia resource has not been downloaded to a local end, the multimedia resource information is obtained, and the complete multimedia resource is then downloaded automatically when the network environment is favorable, thereby achieving a multimedia management method of localization of a multimedia resource from multimedia resource information, and enriching multimedia management functions of a terminal.

Further areas of applicability will become apparent from the description provided herein. The description and specific examples in this summary are intended for purposes of illustration and are not intended to limit the scope of the present disclosure.

### DRAWINGS

The drawings described herein are for illustrative purposes of selected various embodiments and not all possible implementations, and are not intended to limit the scope of the present disclosure.

To describe the technical solutions of the various embodiments of the present disclosure or the existing technology more clearly, the following briefly introduces the accompanying drawings. The accompanying drawings in the following description show select embodiments of the present disclosure, and a person of ordinary skill in the art may still derive other drawings from these accompanying drawings without creative efforts.

FIG. 1 is a flowchart of a method for managing a multimedia resource according to various embodiments;

FIG. 2 is a flowchart of a method for managing a multimedia resource according to various embodiments;

FIG. 3 is a structural diagram of an apparatus for managing a multimedia resource according to various embodiments; and

FIG. 4 is a structural diagram of an information acquisition unit according to various embodiments.

Corresponding reference numerals indicate corresponding parts throughout the several views of the drawings.

### DETAILED DESCRIPTION

Example embodiments will now be described more fully with reference to the accompanying drawings.

The following describes the various embodiments of the present disclosure in detail with reference to the accompanying drawings. The described embodiments are select embodiments of the present disclosure rather than all of the embodiments. All other embodiments obtained by a person of ordinary skill in the art based on the embodiments of the present disclosure without creative efforts shall fall within the protection scope of the present disclosure.

Existing music playing applications on a terminal (such as a personal computer, a mobile phone, and a tablet computer) are generally capable of both adding a song as a favorite and synchronizing a file of a song, That is, synchronizing a song between different terminals. However, in existing methods of adding a song as a favorite and the synchronization of a song, it may occur that only the information of a song is added as a favorite and is synchronized, but a file of the song is not obtained locally. To listen to the song, a user is required to further download or synchronize the file of the song, which is undesirable.

Various embodiments of the present disclosure provide a method for managing a multimedia resource based on the above conditions. That is, when any multimedia resource that has not been downloaded is found, a network environment is immediately detected. If the network environment is favorable, download of the multimedia resource is started automatically, thereby greatly improving the existing approaches for managing multimedia resources. Specific descriptions are provided below with reference to each embodiment.

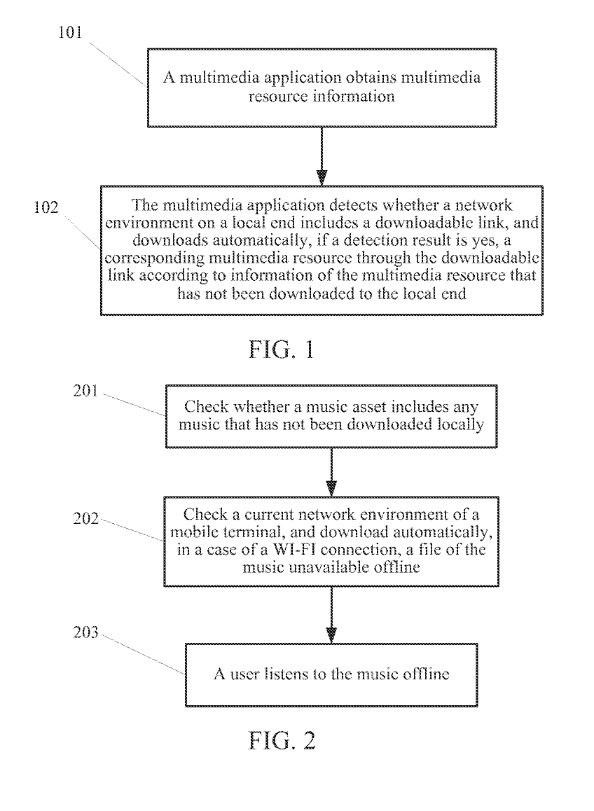

FIG. 1 is a flowchart of a method for managing a multimedia resource according to various embodiments. The method may be used in a multimedia player or another multimedia application, which may specifically include the following:

Block 101: A multimedia application obtains multimedia resource information, the multimedia resource information including information of a multimedia resource that has not been downloaded to a local end. The multimedia resource may include a music resource, a video resource, or the like. Music resource information may include, for example, a song list and songs in the song list, both of which may be presented in the form of a user interface (UI) of the list. Specifically, the multimedia resource information includes a local favorite song list and a songs-to-be-downloaded list.

In this example, the multimedia resource information obtained by the multimedia application may include information of a multimedia resource that is added as a favorite locally by a user, or may further include information of a multimedia resource that has been added by a user as a favorite on another terminal and synchronized to a cloud server. For example, an account may be used to log on to the multimedia application, and a multimedia application that is logged on to by using the same account may acquire, from a cloud server, a sharable multimedia resource and multimedia resource information in the same account.

The multimedia resource information may be obtained when a user uses the multimedia application for the first time or when a change occurs in the multimedia resource information. For example, in the case of synchronization, this block may specifically include performing multimedia resource synchronization between the local end and the another terminal and obtaining, by the multimedia application, synchronized multimedia resource information.

It may be further determined whether it is necessary to start detection of a network environment and download, that is, this may specifically include obtaining, by the multimedia application, changed multimedia resource information, detecting whether the changed multimedia resource information includes the information of the multimedia resource that has not been downloaded to the local end, and starting, if a detection result is yes, block 102, or otherwise, ending the process. Alternatively, this block is started when it is found that the multimedia resource information is accessed or changed, or the above detection procedure may also be started regularly.

Block 102: The multimedia application detects whether a network environment on the local end includes a downloadable link and downloads automatically, if a detection result is yes, the corresponding multimedia resource through the downloadable link according to the information of the multimedia resource that has not been downloaded to the local end.

The downloadable link refers to a network connection accessible by the local end to download a resource. Considering that multimedia resources generally have a large data flow and charging standards vary between different network connections, to reduce a network charge for the user, a predefined non-flow based charging connection may be used for downloading. The non-flow based charging connection refers to a network connection for which charging is not performed based on a download flow, such as a LAN connection that does not involve any charge on the local end, or a connection for which charging is not performed based on a data flow, for example, a Wi-Fi connection.

The above method is further described below by using an example of a music resource. According to various embodiments, a concept of a music asset is developed and includes a song list created by a user, songs added as favorites, downloaded files of songs, and all music information related to the user, which are generally referred to as the music asset. A user terminal refers to a mobile terminal. The music asset on the mobile terminal includes music from two sources: music locally added by the user as favorites and music added by the user as favorites on another terminal, synchronized to a cloud server, and is then delivered by the cloud server to each terminal through synchronization. Change of the music asset refers to a change in the song list or songs in the song list, including addition of a song list, deletion of a song list, addition of a song, deletion of a song, and the like.

FIG. 2 is a flowchart of a method for managing a multimedia resource described by using an example of a music resource according to various embodiments. The procedure includes the following:

Block 201: When a user starts a music application for the first time, or a change occurs in a music asset of a music application, check whether the music asset includes any music that has not been downloaded locally and mark such music as music unavailable offline.

Block 202: Check a current network environment of a mobile terminal and download automatically, in a case of a Wi-Fi connection, a music file of the music unavailable offline. Because data flow in a Wi-Fi network environment has a very low tariff, a network charge of the user may be reduced. In a case of an operator network, for example, a General Packet Radio Service (GPRS) network, or a Third Generation (3G) network, automatic download does not take place, so as to avoid consumption of a data flow without awareness by the user. When multiple music files need to be downloaded, these files are downloaded one by one in sequence.

Block 203: The user listens to the music offline. In this case, since the music has been downloaded locally, no data flow is consumed, and the user can listen to the music more smoothly without paying any attention to management of music download.

In view of the foregoing description of the various embodiments, if multimedia resource information is already available locally but a multimedia resource has not been downloaded to a local end, the multimedia resource information is obtained, and the complete multimedia resource is then downloaded automatically when a network environment is favorable, thereby achieving a multimedia management method of localization of a multimedia resource from multimedia resource information, and enriching multimedia management functions of a mobile terminal.

In a case of a music resource, for example, a process of localization of a file of a song from song information for a music asset of a user is achieved. The user can listen to music offline without any special operation, thereby reducing a charge of a data flow and simplifying an operation of the user.

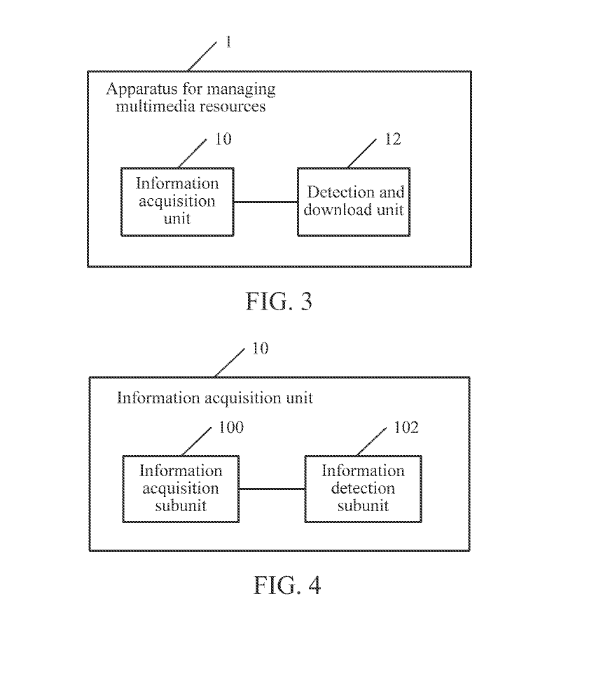

FIG. 3 is a structural diagram of an apparatus for managing a multimedia resource according to various embodiments. The apparatus 1 includes an information acquisition unit 10 configured to obtain multimedia resource information, the multimedia resource information including information of a multimedia resource that has not been downloaded to a local end; and a detection and download unit 12, configured to detect whether a network environment on the local end includes a downloadable link, and download automatically, if a detection result is yes, the corresponding multimedia resource through the downloadable link according to the information of the multimedia resource that has not been downloaded to the local end.

The information acquisition unit 10 may be further configured to obtain synchronized multimedia resource information after multimedia resource synchronization is performed between the local end and another terminal. Furthermore, as shown in FIG. 4, the information acquisition unit 10 may specifically include an information acquisition subunit 100 configured to obtain changed multimedia resource information; and an information detection subunit 102, configured to detect whether the changed multimedia resource information includes the information of the multimedia resource that has not been downloaded to the local end, and start, if a detection result is yes, the detection and download unit to perform detection and download.

The downloadable link detected by the detection and download unit 12 is a predefined non-flow based charging connection, and the non-flow based charging connection refers to a network connection for which charging is not performed based on a download flow. The multimedia resource information acquired by the information acquisition unit 10 may include a local favorite song list and a songs-to-be-downloaded list.

Various embodiments of the present disclosure further disclose a multimedia player, including the apparatus for managing a multimedia resource as described above. The details are no longer described one by one herein.

The functions of the modules and all specific terms in the above various apparatus embodiments are consistent with those in the various method embodiments as described above. The details are no longer described herein.

According to various embodiments of the present disclosure, if multimedia resource information is already available locally but a multimedia resource has not been downloaded to a local end, the multimedia resource information is obtained and the complete multimedia resource is then downloaded automatically when a network environment is favorable, thereby achieving a multimedia management method of localization of a multimedia resource from multimedia resource information and enriching multimedia management functions of a terminal. According to various embodiments, the mobile terminal may be a mobile phone (or called a “cellular phone”), a portable computer having a communication function, or the like.

A person of ordinary skill in the art may understand that all or some of the blocks in the methods of the foregoing embodiments may be implemented by a computer program instructing relevant hardware. The program may be stored in a computer-readable storage medium. When the program is run, the procedures of the embodiments of the foregoing method are performed. The storage medium may be a magnetic disk, an optical disk, a Read-Only Memory (ROM), a Random Access Memory (RAM), and the like.

The above description is merely various embodiments of the present disclosure, but is certainly not intended to limit the scope of the claims of the present disclosure. Therefore, equivalent changes made according to the claims of the present disclosure shall still fall within the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for managing multimedia resources, comprising:
obtaining, by a multimedia application, multimedia resource information, the multimedia resource information comprising information of a multimedia resource that has not been downloaded to a local end; and
detecting, by the multimedia application, whether a network environment on the local end comprises a downloadable link, and downloading automatically, if a detection result is yes, the corresponding multimedia resource through the downloadable link according to the information of the multimedia resource that has not been downloaded to the local end.

2. The method according to claim 1, wherein the obtaining, by a multimedia application, multimedia resource information comprises:
obtaining, by the multimedia application, changed multimedia resource information, detecting whether the changed multimedia resource information comprises the information of the multimedia resource that has not been downloaded to the local end; and starting, if a detection result is yes, the step of the detecting, by the multimedia application, whether a network environment on the local end comprises a downloadable link.

3. The method according to claim 1, wherein the obtaining, by a multimedia application, multimedia resource information comprises:
synchronizing multimedia resources between the local end and another terminal; and
obtaining, by the multimedia application, synchronized multimedia resource information.

4. The method according to claim 1, wherein the downloadable link is a predefined non-flow based charging connection, and the non-flow based charging connection refers to a network connection for which charging is not performed based on a download flow.

5. The method according to claim 2, wherein the downloadable link is a predefined non-flow based charging connection, and the non-flow based charging connection refers to a network connection for which charging is not performed based on a download flow.

6. The method according to claim 3, wherein the downloadable link is a predefined non-flow based charging connection, and the non-flow based charging connection refers to a network connection for which charging is not performed based on a download flow.

7. The method according to claim 4, wherein the non-flow based charging connection refers to a Wi-Fi connection.

8. The method according to claim 7, wherein the multimedia resource information comprises a local favorite song list and a songs-to-be-downloaded list.

9. An apparatus for managing multimedia resources, comprising:
an information acquisition unit, configured to obtain multimedia resource information, the multimedia resource information comprising information of a multimedia resource that has not been downloaded to a local end; and
a detection and download unit, configured to detect whether a network environment on the local end comprises a downloadable link, and download automatically, if a detection result is yes, the corresponding multimedia resource through the downloadable link according to the information of the multimedia resource that has not been downloaded to the local end.

10. The apparatus according to claim 9, wherein the information acquisition unit comprises:
an information acquisition subunit, configured to obtain changed multimedia resource information; and
an information detection subunit, configured to detect whether the changed multimedia resource information comprises the information of the multimedia resource that has not been downloaded to the local end, and start, if the detection results is yes, the detection and download unit to perform detection and download.

11. The apparatus according to claim 9, wherein the information acquisition unit is further configured to obtain synchronized multimedia resource information after multimedia resource synchronization has been performed between the local end and another terminal.

12. The apparatus according to claim 9, wherein the downloadable link detected by the detection and download unit is a predefined non-flow based charging connection, and the non-flow based charging connection refers to a network connection for which charging is not performed based on a download flow.

13. The apparatus according to claim 10, wherein the downloadable link detected by the detection and download unit is a predefined non-flow based charging connection, and the non-flow based charging connection refers to a network connection for which charging is not performed based on a download flow.

14. The apparatus according to claim 11, wherein the downloadable link detected by the detection and download unit is a predefined non-flow based charging connection, and the non-flow based charging connection refers to a network connection for which charging is not performed based on a download flow.

15. A multimedia player, comprising the apparatus for managing multimedia resources, wherein the apparatus comprises:
an information acquisition unit, configured to obtain multimedia resource information, the multimedia resource information comprising information of a multimedia resource that has not been downloaded to a local end; and
a detection and download unit, configured to detect whether a network environment on the local end comprises a downloadable link, and download automatically, if a detection result is yes, the corresponding multimedia resource through the downloadable link according to the information of the multimedia resource that has not been downloaded to the local end.

16. The multimedia player according to claim 15, wherein the information acquisition unit comprises:
an information acquisition subunit, configured to obtain changed multimedia resource information; and
an information detection subunit, configured to detect whether the changed multimedia resource information comprises the information of the multimedia resource that has not been downloaded to the local end, and start, if the detection results is yes, the detection and download unit to perform detection and download.

17. The multimedia player according to claim 15, wherein the information acquisition unit is further configured to obtain synchronized multimedia resource information after multimedia resource synchronization has been performed between the local end and another terminal.

18. The apparatus according to claim 15, wherein the downloadable link detected by the detection and download unit is a predefined non-flow based charging connection, and the non-flow based charging connection refers to a network connection for which charging is not performed based on a download flow.
